(19) United States
(12) Patent Application Publication
(10) Pub. No.: US 2024/0112265 A1
(43) Pub. Date: Apr. 4, 2024

(54) Method and System for Computing Correct Income of a Security Using Undistributed Income

(71) Applicant: BATTLELINE TECHNOLOGIES, LLC, Delray Beach, FL (US)

(72) Inventors: David Boydell, Sonoma, CA (US); Jeremy Roseberry, Delray Beach, FL (US)

(73) Assignee: FairShares, Inc., Delray Beach, FL (US)

(21) Appl. No.: 18/273,399

(22) PCT Filed: Feb. 1, 2022
(86) PCT No.: PCT/US22/14780

§ 371 Date: Jul. 20, 2023

Related U.S. Application Data
(60) Provisional application No. 63/144,450, filed on Feb. 1, 2021.
(60) Provisional application No. 63/214,150, filed on Jun. 23, 2021.

(51) Int. Cl. G06Q 40/06

(52) U.S. Cl. CPC G06Q 40/06

(57) ABSTRACT

A system for computing correct income includes: a server configured to retrieve user data; a system database operably connected to the server, wherein the server is further configured to compute, using the undistributed income, using one or more of retrieved user data, security data, and distribution data, the security's correct income on the first distribution after the purchase of the security where the security is still owned at the end of a first payment period after the purchase, using an equation:

$$Correct Income for Security Purchase = D * S - Undistributed Income = \{ \begin{matrix}0 for a purchase of a stock ; \\ S * ( D * ( 1 - ( T / L ) ) , for a purchase of an investment fund\end{matrix} , \qquad ( 7 )$$

where: S=number of shares purchased, D=the total distribution per share, T=the amount of elapsed time since the payment period began, and L=the total amount of time in the payment period.

### PRIORITY CLAIM

The present application claims the priority benefit of U.S. provisional patent application No. 63/144,450 filed Feb. 1, 2021 and entitled “Method and System for Computing Per-Share Distributable Income of a Security,” and of U.S. provisional patent application No. 63/214,150 filed Jun. 23, 2021 and entitled “Method and System for Computing Investment Risk Associated with Purchasing and Selling Income-Producing Securities,” the disclosures of which are incorporated herein by reference.

### CROSS-REFERENCE TO RELATED APPLICATION

This application contains subject matter that is related to the subject matter of the following applications, which are assigned to the same assignee as this application. The below-listed application is hereby incorporated herein by reference in its entirety: “METHOD AND SYSTEM FOR COMPUTING HIDDEN INVESTMENT COST DISCLOSABLE TO PURCHASERS AND SELLERS OF INCOME-PRODUCING SECURITIES,” by Boydell, et al., co-filed herewith.

### SUMMARY

Embodiments of this invention provide a method and system for computing correct income of a security using undistributed income.

A system for computing correct income to a user on a first distribution received after a purchase of a security using undistributed income includes: a server configured to control the system, the server further configured to compute, using the undistributed income, the correct income to the user on the first distribution received after the purchase of the security, the server further configured to retrieve user data usable by the system, the user data comprising user purchase data regarding a purchase of the security by the user, the user data further comprising information on whether the security is still owned at the end of a first payment period after the purchase of the security; a system database operably connected to the server, the system database comprising one or more of security data usable by the system and distribution data usable by the system, wherein the server is further configured to compute, using the undistributed income, using one or more of the retrieved user data, the security data, and the distribution data, the security's correct income to the user on the first distribution after the purchase of the security where the security is still owned at the end of the first payment period after the purchase, using an equation:

$$Correct Income for Security Purchase = D * S - Undistributed Income = \{ \begin{matrix}0 for a purchase of a stock ; \\ S * ( D * ( 1 - ( T / L ) ) , for a purchase of an investment fund\end{matrix} , \qquad ( 7 )$$

where: S=number of shares purchased, D=the total distribution per share, T=the amount of elapsed time since the payment period began, and L=the total amount of time in the payment period; and storage configured to store one or more of the user data, the computed correct income, the undistributed income, and the computed distribution index, wherein the server is further configured to retrieve the user data from the storage, wherein the server is further configured to transmit to the storage one or more of the computed correct income and the undistributed income.

A method for computing correct income to a user on a first distribution received after a purchase of a security using undistributed income, comprising: using a system comprising a server configured to control the system, the server further configured to compute, using the undistributed income, the correct income to the user on the first distribution received after the purchase of the security, the server further configured to retrieve user data usable by the system, the user data comprising user purchase data regarding a purchase of the security by the user, the user data further comprising information on whether the security is still owned at the end of a first payment period after the purchase of the security, the system further comprising a system database operably connected to the server, the system database comprising one or more of security data usable by the system and distribution data usable by the system, retrieving, by the server, user data; computing, by the server, using the undistributed income, using one or more of the retrieved user data, the security data, and the distribution data, the security's correct income to the user on the first distribution after the purchase of the security where the security is still owned at the end of the first payment period after the purchase, using an equation:

$$Correct Income = D * S - Undistributed Income = \{ \begin{matrix}0 for a purchase of a stock ; \\ S * ( D * ( 1 - ( T / L ) ) , for a purchase of an investment fund\end{matrix} , \qquad ( 6 )$$

where: S=number of shares purchased, D=the total distribution per share, T=the amount of elapsed time since the payment period began, and L=the total amount of time in the payment period, the system further comprising storage configured to store one or more of the user data, the computed correct income, the undistributed income, and the computed distribution index, wherein the server is further configured to retrieve the user data from the storage; and transmitting, by the server, to the storage, one or more of the computed correct income and the undistributed income.

A system for computing correct income to a user on a first distribution received after a purchase of a security using undistributed income includes: a server configured to control the system, the server further configured to compute, using the undistributed income, the correct income to the user on the first distribution received after the purchase of the security, the server further configured to retrieve user data usable by the system, the user data comprising user purchase data regarding a purchase of the security by the user, the user data further comprising information on whether the security is still owned at the end of a first payment period after the purchase of the security; a system database operably connected to the server, wherein the system database comprises both a security database and a distribution database, wherein the security database comprises security data, the security data comprising a list of all income-producing securities for a tax jurisdiction of interest, the security data further comprising a tag identifying a security type to be processed, wherein the system database comprises a relational database service, wherein the distribution database comprises distribution data regarding a security distribution, wherein the distribution database further comprises historical security data, wherein the historical security data comprises data on historical security distributions, wherein the distribution database is configured to obtain distribution data from an external data source; a user device operated by the user, the user device operably connected to the server, wherein the server communicates with the user device via one or more of a network connection, the cloud, and a wired connection, wherein the server comprises a login module suitable for use by the user device to log into the server, wherein the server further comprises a user interface suitable for use by the user device to interface with the server following a successful login to the server, wherein the server retrieves the user data from the user device through the user interface, wherein the server is further configured to compute, using the undistributed income, using the retrieved user data, the security data, and the distribution data, the security's correct income to the user on the first distribution after the purchase of the security where the security is still owned at the end of the first payment period after the purchase, using an equation:

$$Correct Income = D * S - Undistributed Income = \{ \begin{matrix}0 for a purchase of a stock ; \\ S * ( D * ( 1 - ( T / L ) ) , for a purchase of an investment fund\end{matrix} , \qquad ( 6 )$$

where: S=number of shares purchased, D=the total distribution per share, T=the amount of elapsed time since the payment period began, and L=the total amount of time in the payment period, wherein the storage is further configured to store both the computed correct income and the undistributed income, wherein the server is further configured to transmit to the storage both the computed correct income and the undistributed income, wherein the server is further configured to export both the computed correct income and the undistributed income to one or more of the user device and an intermediary authorized by the user, wherein the intermediary comprises one or more of an accountant, a tax advisor, a broker-dealer, and a custodian, wherein the security distributes one or more distribution types, wherein the distribution types are selected from a list comprising: income, cash, a short-term capital gain, a long-term capital gain, a special cash distribution, and a return of capital; storage configured to store one or more of the user data, the computed correct income, the undistributed income, and the computed distribution index, wherein the server is further configured to retrieve the user data from the storage, wherein the server is further configured to compute a correct income for each distribution type from the security, wherein the server transmits to the storage the correct incomes computed for each distribution type; and a network configured to operably connect two or more of the server, the user device, the system database, the securities data source, the storage, and the intermediary, the network comprising one or more of a server-device network connection operably connecting the server and the user device, a server-database network connection operably connecting the server and the system database, a server-storage network connection operably connecting the server and the storage, and a server-intermediary network connection operably connecting the server and the intermediary.

### BRIEF DESCRIPTION OF THE FIGURES

The figures depict various embodiments for purposes of illustration only. One skilled in the art will readily recognize from the following discussion that alternative embodiments of the structure and methods illustrated herein may be employed without departing from the principles described herein.

FIG. 1 illustrates an exemplary system for computing correct income of a security using undistributed income.

FIG. 2 illustrates an exemplary system for computing correct income of a security using undistributed income.

FIG. 3 is a graph showing a price of a security plotted against a day of the security's payment period calculated by a system for computing correct income of a security using undistributed income.

FIGS. 4A-4B are a pair of bar graphs showing how the system creates a distribution index for a slightly more complex example.

FIG. 5 is a flow chart of a method for computing correct income of a security using undistributed income.

### DETAILED DESCRIPTION

While the present invention is susceptible of embodiment in many different forms, there is shown in the drawings and will herein be described in detail one or more specific embodiments, with the understanding that the present disclosure is to be considered as exemplary of the principles of the invention and not intended to limit the invention to the specific embodiments shown and described. In the following description and in the several figures of the drawings, like reference numerals are used to describe the same, similar or corresponding parts in the several views of the drawings.

The embodiments of the invention fix a problem in global stock markets that causes investors purchasing securities to pay taxes they should not owe. Global stock markets use a last holder of record system to distribute income to shareholders. In the last holder of record system, the last investor to own shares on a last day of the payment period is entitled to the entire financial distribution, regardless of how long those shares are held. For example, if investor one has held shares of an income-producing security for one year and then sells those shares to investor two one day before the end of the payment period, investor one will not receive any of the upcoming distribution and investor two will receive the entire distribution, even though investor two only owned the shares for one day.

The current last holder of record system includes, in a price of a security, the security's undistributed income that is payable by the security to the security's shareholders. Therefore, investors who purchase income-producing securities are purchasing two separate and very different interests in those securities. The majority of a investor's capital is used to purchase the actual security. However, a smaller portion of the investor's capital is used to purchase already earned, yet undistributed income the security will distribute on a future date. The investor's capital that was used to purchase this secondary interest in the security's undistributed income will be returned to the investor as a fully distribution. However, this return of the security's undistributed income should not be income. This constitutes a return of a portion of the investor's initial capital and should therefore be excluded from taxation since no income was earned. This is a problem with the current last holder of record system.

For example, if an investor purchases a security for $100 per share that will pay a $2.00 distribution tomorrow, when the distribution is paid, the security's price will drop from $100 per share to $98.00, and the investor will receive a $2.00 per share distribution. This may appear to be a zero-sum game because the investor has lost $2.00 in the value of their shares and has gained $2.00 in distributions. However, the investor loses under this scenario because the investor will owe tax on the $2.00 distribution that the investor receives. If we assume a 50% tax rate, the investor will owe $1.00 in taxes which leaves the investor with a net investment value of $99.00. This investor lost 1% of his or her capital in less than 24 hours.

The reason this investor experienced a loss is that the investor was taxed on a return of their capital when the distribution they purchased was returned to them. A return of capital should not be taxable. Embodiments of the invention provide a method and system for correcting this flaw in the existing system.

Embodiments of the invention determine an amount of a distribution that represents a return of the user's capital and should therefore be excluded from taxation. Embodiments of the invention further determine an amount of the distribution that was earned and thus is properly taxable.

Components of the system for computing correct income of a security using undistributed income can be constructed using a cloud-based system architecture. Alternatively, or additionally, the system can be constructed using physical onsite components.

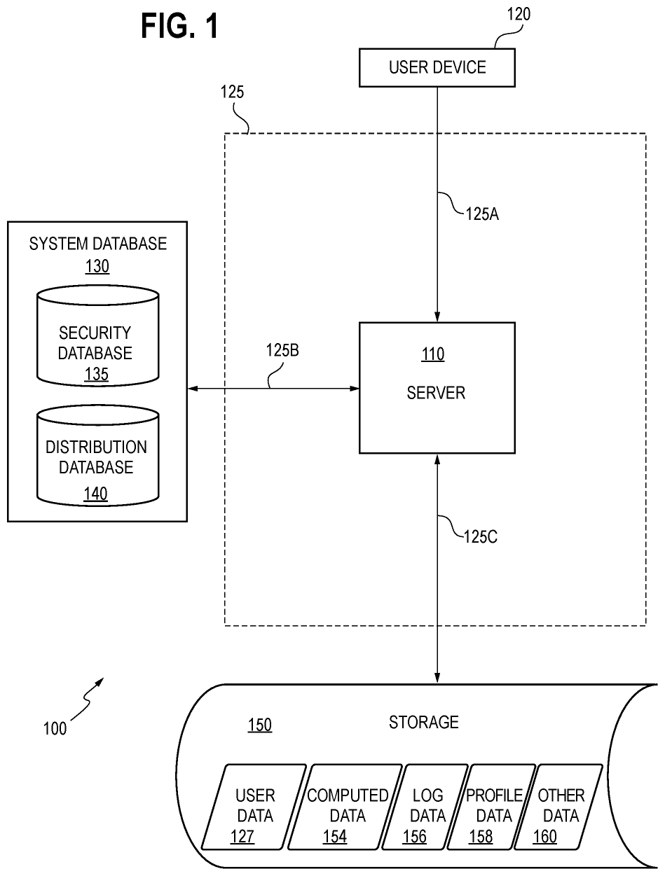

FIG. 1 illustrates an exemplary system 100 for computing correct income of a security using undistributed income. FIG. 1 illustrates a system 100 that can be constructed and operated using physical onsite components. Alternatively, or additionally, the system 100 illustrated in FIG. 1 could also be constructed and operated using a cloud-based system architecture. Preferably, but not necessarily, FIG. 1 depicts the system 100 suitable for use with physical onsite components. For example, in the case of a cloud-based system architecture, the cloud-based system comprises a system sold by Amazon Web Services (AWS), a subsidiary of Amazon.com of Seattle, Washington (www.amazon.com).

The system 100 comprises a server 110, the server 110 configured to do one or more of process data and control the system 100. The server 110 comprises computer code usable to process the data. The system 100 further comprises a user device 120 operated by a user (not shown), also known as a user, the user device 120 operably connected to the server 110. For example, the user device 120 comprises one or more of a desktop computer, a notebook computer, a tablet, a mobile telephone, a smart watch, and another user device. The server 110 and the user device 120 are configured to communicate with each other. As depicted, the system further comprises a network 125.

For example, the server 110 communicates with the user device 120 via one or more of a network connection using the network 125, the cloud, a wired connection, and another connection. The network comprises a server-device network connection 125A operably connecting the server 110 and the user device 120. As depicted, the server 110 communicates with the user device 120 via the server-device network connection 125A. The network 125 comprises one or more of a wired network, a wireless network, and another network. Preferably, but not necessarily, the network 125 comprises a wired network.

The server 110 comprises a login module (not shown) suitable for use by the user device 120 to log into the server 110. The system 100 further comprises a user interface (not shown) suitable for use by the user device 120 to interface with the server 110 following a successful login to the server 110. Via the server-device network connection 125A, which connects the server 110 to the user device 120, the user (not shown) uses the user device 120 to access the login module provided by the server 110. For example, the server-device network connection 125A can comprise an Internet connection, while the rest of the network 125 comprises a wired network. Using the login module, the user device 120 accesses the server 110 via the user interface. Using the user device 120 via the user interface, the user (not shown) uploads user data 127. The user interface transmits the user data 127 to the server 110 via the server-device network connection 125A.

The system 100 further comprises a system database 130, the system database 130 operably connected via the server-database network connection 125B to the server 110. The system database 130 comprises one or more of a security database 135 and a distribution database 140. Preferably, but not necessarily, the system database 130 comprises both a security database 135 and a distribution database 140. Alternatively, or additionally, one or more of the security database 135 and the distribution database 140 are located outside of the system database 130. For example, if both the security database 135 and the distribution database 140 are not comprised in the system database 130, an operable network connection (not shown) will connect the security database 135 to the server 110, and a second operable network connection (not shown) will connect the distribution database 140 to the server 110.

The security database 135 comprises a master list of securities including security names, security ticker symbols, and other relevant information. Preferably, but not necessarily, the security database 135 comprises security data, the security data comprising a list of income-producing securities for a tax jurisdiction of interest. Most preferably, but not necessarily, the security database 135 comprises a list of all income-producing securities for the tax jurisdiction of interest. For example, the security database 135 further comprises a security tag identifying a security type to be processed. The security database 135 uses the security tags to denote what type of security each security is. For example, the security tag states whether a security comprises a stock or an investment fund. For example, the security tag identifies how the securities income will be taxed. For example, the security tag further states whether the security is or non-taxable in the jurisdiction of interest. Preferably, but not necessarily, the security database 135 comprises a relational database service.

The distribution database 140 is configured to do one or more of receive distribution data usable by the system 100 regarding a security distribution from the server 110 and store the distribution data. For example, the distribution data comprises an accounting of all of the distributions made from the securities in the security database 135. The distribution database 140 comprises one or more of a physical distribution database and a cloud-based distribution database. The distribution database 140 is configured to do one or more of receive data from the server 110, store data usable by the server 110, and export the data to the server 110 via the server-database network connection 125B. Preferably, but not necessarily, the distribution database 140 is configured to receive the data from the server 110, store the data usable by the server 110, receive a request from the server 110 for needed data, and export the needed data to the server 110.

Preferably, but not necessarily, the distribution database 140 further comprises historical security data. Preferably, but not necessarily, the historical security data comprises data on historical security distributions. The distribution database 140 may obtain transaction data from an external data source. For example, the external data source can comprise one or more of Bloomberg of New York New York (www.bloomberg.com), FactSet of Norwalk, Connecticut (www.factset.com), Thomson Reuters Corporation of Toronto, Ontario, Canada (www.thomsonreuters.com), and any other external data source.

The system 100 further comprises storage 150 configured to store data. The network 125 comprises one or more of a server-device network connection 125A operably connecting the server 110 and the user device 120, a server-database network connection 125B operably connecting the server 110 and the system database 130, and a server-storage network connection 125C operably connecting the server 110 and the storage 150. Preferably, but not necessarily, and as depicted, the network 125 comprises a server-device network connection 125A operably connecting the server 110 and the user device 120, a server-database network connection 125B operably connecting the server 110 and the system database 130, and a server-storage network connection 125C operably connecting the server 110 and the storage 150.

The server 110 retrieves the user data 127 from the user device 120 via the server-device network connection 125A. Via the server-database network connection 125B, the server accesses the system database 130 to obtain security information needed to calculate undistributed income. Using the security information thereby obtained, and using the method for computing undistributed income, the server 110 processes the user data 127, computing the undistributed income, thereby producing computed data 154. For example, the computed data 154 comprises computed correct income. The server 110 transmits one or more of the user data 127 and the computed data 154 to the storage 150 via the server-storage network connection 125C that connects the server 110 to the storage 150. Preferably, but not necessarily, the server 110 transmits both the user data 127 and the computed data 154 to the storage 150 via the server-storage network connection 125C. The storage 150 stores one or more of the user data 127, the computed correct income, the undistributed income, and the computed distribution index. The storage 150 also stores one or more of the computed data 154, log data 156, profile data 158, and other data 160. The log data 156 comprises a record of events taking place in the system 100 including a user login, a user upload of user data, a transmission of data over the server-database network connection 125B between the server 110 and the system database 130, a transmission of data over the server-storage network connection 125B between the server 110 and the storage 150, a user request for the computed data 154, and any other system event. The profile data 158 comprises profile information submitted by a user when creating a user profile. Profile information comprises one or more of a profile picture, a username, a name, an address, a telephone number, a facsimile number, an electronic mail (email) address, a social media handle, and other profile information. For example, the profile picture comprises one or more of a picture of the user and another picture. The other data 160 comprises one or more of data relating to the system 100, data used to produce a metric regarding the system 100, a dashboard configured to measure data processed by a user, and further other data.

One or more of a user using the user device 120 and an intermediary (not shown) authorized by the user can request to receive the computed data 154 comprising the computed correct income. The server 110 then exports the computed data 154 comprising the computed correct income back to the one or more of the user device 120 and the intermediary authorized by the user. Preferably, but not necessarily, the server 110 is configured to export one or more of the computed correct income and the undistributed income to one or more of the user device and the intermediary. Most preferably, but not necessarily, the server 110 is configured to export both the computed correct income and the undistributed income to the one or more of the user device and the intermediary.

For example, the intermediary comprises one or more of an accountant, a tax advisor, a broker-dealer, and a custodian. The network further comprises a server-intermediary network connection operably connecting the server 110 and the intermediary.

Using the user device 120 over the server-device network connection 125A, the user can request the computed data 154. Alternatively, or additionally, the server 110 instructs the storage 150 to send the requested computed data 154 to the user device 120 via the server-storage network connection 125C. The server 110 then sends the requested computed data 154 via the server-device network connection 125A via the user device 120 to one or more of the user (not shown) and the intermediary (not shown) appointed by the user.

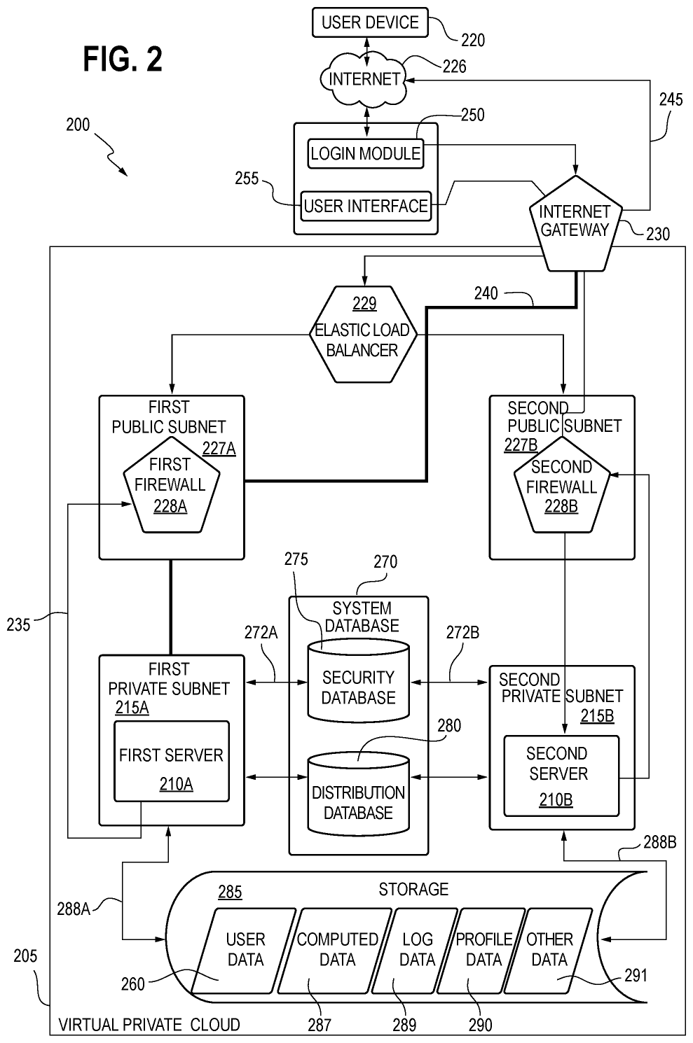

FIG. 2 illustrates an exemplary system 200 for computing correct income of a security using undistributed income. FIG. 2 illustrates a system 200 that is constructed and operated using a cloud-based system architecture. For example, the cloud-based system comprises a system sold by Amazon Web Services (AWS), a subsidiary of Amazon.com of Seattle, Washington (www.amazon.com).

The system 200 comprises a virtual private cloud 205. The virtual private cloud 205 comprises the components of the system that run method and system for computing correct income of a security using undistributed income. The virtual private cloud 205 comprises a server 210A-210B. As depicted, the virtual private cloud 205 comprises two servers, a first server 210A and a second server 210B. The servers 210A-210B are configured to do one or more of process data and control the virtual private cloud 205. For example, one or more of the servers comprise Amazon Elastic Cloud Compute (EC2) servers operated by Amazon Web Services (AWS), a subsidiary of Amazon.com of Seattle, Washington (www.amazon.com). The system optionally further comprises a private subnet 215A-215B. As depicted, the virtual private cloud 205 comprises two private subnets, a first private subnet 215A and a second private subnet 215B. At least one of the servers 210A-210B can optionally be comprised in the private subnet 215A-215B. As depicted, a first private subnet 215A comprises the first server 210A and a second private subnet 215B comprises the second server 210B.

The servers 210A-210B each comprise computer code usable to process the data. The system 200 further comprises a user device 220 operated by a user (not shown), also known as a user, the user device 220 operably connected to the servers 210A-210B. For example, the user device 220 comprises one or more of a desktop computer, a notebook computer, a tablet, a mobile telephone, a smart watch, and another user device. The servers 210A-210B and the user device 220 are configured to communicate with each other. As depicted, the system further comprises a network 226 the network 226 configured to connect components of the virtual private cloud 205. For example, the network 226 one or more of a wired network, a wireless network, and another network. Preferably, but not necessarily, the network 226 comprises one or more of a wired network and the Internet.

For example, the servers 210A-210B communicate with the user device 220 via one or more of a network connection using the Internet 226, the cloud, a wired connection, and another connection. As depicted, the user device 220 is operably connected to each of the servers 210A-210B. In FIG. 2, unlike in FIG. 1, the operable connections between the user device 220 and the servers 210A-210B pass through multiple other components.

The private cloud 205 further comprises a public subnet 227A-227B. The private cloud 205 further comprises a firewall 228A-228B. As depicted, the private cloud 205 further comprises a first public subnet 227A, a second private subnet 227B, a first firewall 228A, a second firewall 228B, an elastic load balancer 229, and an Internet gateway 230. The elastic load balancer 229 is configured to activate an appropriate number of servers 210A-210B as needed to handle data being uploaded through the user device 220. The first public subnet 227A comprises the first firewall 228A. The second public subnet 227B comprises the second firewall 228B. For example, the first firewall 228A comprises a Network Address Translation (NAT) gateway 228A operated by Amazon Web Services (AWS), a subsidiary of Amazon.com of Seattle, Washington (www.amazon.com). For example, the second firewall 228B comprises an NAT gateway 228B operated by Amazon Web Services (AWS), a subsidiary of Amazon.com of Seattle, Washington (www.amazon.com). The Internet gateway 230 is operably connected with the first public subnet 227A. The Internet gateway 230 is operably connected with the second public subnet 227B. The Internet gateway 230 is also operably connected with the elastic load balancer 229.

As depicted, the first server 210A communicates with the user device 220 via a highlighted path passing first through the first private subnet 215A that comprises the first server 210A, then through a first-private-subnet-first-public-subnet connection 235 to the first public subnet 227A comprising the first firewall 228A, then through a first-public-subnet-Internet gateway connection 240 to the Internet gateway 230, then through an Internet-gateway-device connection 245 over the Internet 226 to the user device 220.

The Internet gateway 230 provides one or more of a login module 250 suitable for use by the servers 210A-210B to log into the servers 210A-210B and a user interface 255 suitable for use by the Internet gateway 230 to provide an interface between the virtual private cloud 205 and the user device 220 following a successful login to the servers 210A-210B. Via the user interface 255 and the Internet gateway 230, the user (not shown) uploads user data 260 to one or more of the servers 210A-210B.

The system 200 further comprises a system database 270, the system database 270 operably connected via a first server-database network connection 272A to the first server 210A, the system database 270 operably connected via a second server-database network connection 272B to the second server 210B. The system database 270 comprises one or more of a security database 275 and a distribution database 280. Preferably, but not necessarily, the system database 270 comprises both a security database 275 and a distribution database 280. Alternatively, or additionally, one or more of the security database 275 and the distribution database 280 are located outside of the system database 270. For example, if both the security database 275 and the distribution database 280 are not comprised in the system database 270, an operable network connection (not shown) will connect the security database 275 to the servers 210A-210B, and a second operable network connection (not shown) will connect the distribution database to the servers 210A-210B.

The security database 275 comprises a master list of securities including security names, security ticker symbols, and other relevant information. Preferably, but not necessarily, the security database 275 comprises security data, the security data comprising a list of income-producing securities for a tax jurisdiction of interest. Most preferably, but not necessarily, the security database 275 comprises a list of all income-producing securities for the tax jurisdiction of interest. The security database 275 uses security tags to denote what type of security each security is. For example, the security tag states whether a security comprises a stock or an investment fund. For example, the security tag identifies how the securities income will be taxed. For example, the security tag further states whether the security is taxable or non-taxable in the jurisdiction of interest. Preferably, but not necessarily, the security database 275 comprises a relational database service.

The distribution database 280 is configured to do one or more of receive distribution data usable by the system 200 regarding a security distribution from the servers 210A-210B and store the distribution data. For example, the distribution data comprises an accounting of all of the distributions made from the securities in the security database 275. The distribution database 280 comprises one or more of a physical distribution database and a cloud-based distribution database. The distribution database 280 is configured to do one or more of receive data from the servers 210A-210B, store data usable by the servers 210A-210B, and export the data to the servers 210A-210B via the server-database network connection 272A-272B. Preferably, but not necessarily, the distribution database 280 is configured to receive the data from the servers 210A-210B, store the data usable by the servers 210A-210B, receive a request from the servers 210A-210B for needed data, and export the needed data to the servers 210A-210B.

Preferably, but not necessarily, the distribution database 280 further comprises historical security data. Preferably, but not necessarily, the historical security data comprises data on historical security distributions. The distribution database 280 may obtain transaction data from an external data source. For example, the external data source can comprise one or more of Bloomberg of New York New York (www.bloomberg.com), FactSet of Norwalk, Connecticut (www.factset.com), Thomson Reuters Corporation of Toronto, Ontario, Canada (www.thomsonreuters.com), and any other external data source.

The system 200 further comprises storage 285 configured to store data. For example, the storage 285 comprises an S3 storage device operated by Amazon Web Services (AWS), a subsidiary of Amazon.com of Seattle, Washington (www.amazon.com).

The servers 210A-210B retrieve the user data 260 from the user device 220. For example, the servers 210A-210B retrieve the user data 260 through the user interface 255. The servers 210A-210B access the system database 270 to obtain security information needed to calculate undistributed income. Using the security information thereby obtained, and using the method for computing undistributed income, the servers 210A-210B process the user data 260, computing the undistributed income, thereby producing computed data 287. For example, the computed data 287 comprises computed correct income. The servers 210A-210B transmit one or more of the user data 260 and the computed data 287 to the storage 285 via respective server-storage network connections 288A-288B that connect the respective servers 210A-210B to the storage 285. Preferably, but not necessarily, the servers 210A-210B transmit both the user data 260 and the computed data 287 to the storage 285 via the respective server-storage network connections 288A-288B. The storage 285 stores the user data 260. The storage 285 also stores one or more of the computed data 287, log data 289, profile data 290, and other data 291. The log data 289 comprises a record of events taking place in the system 200 including a user login, a user upload of user data, a transmission of data via the respective server-database network connections 272A-272B between the respective servers 210A-210B and the system database 270, a transmission of data via the respective server-storage network connections 288A-288B between the servers 210A-210B and the storage 285, a user request for the computed data 260, and any other system event. The profile data 290 comprises profile information submitted by a user when creating a user profile. Profile information comprises one or more of a profile picture, a username, a name, an address, a telephone number, a facsimile number, an electronic mail (email) address, a social media handle, and other profile information. For example, the profile picture comprises one or more of a picture of the user and another picture. The other data 291 comprises one or more of data relating to the system 200, data used to produce a metric regarding the system 200, a dashboard configured to measure data processed by a user, and further other data.

One or more of a user using the servers 210A-210B and an intermediary (not shown) authorized by the user can request to receive the computed data 287 comprising the computed correct income. One or more of the servers 210A-210B then exports the computed data 287 comprising the computed correct income back to the one or more of the user device 220 and the intermediary authorized by the user. For example, the intermediary comprises one or more of an accountant, a tax advisor, a broker-dealer, and a custodian.

Using the servers 210A-210B, the user can request the computed data 287. Alternatively, or additionally, in response to the user request, the servers 210A-210B instruct the storage 285 to send the requested computed data 287 to the user device 220.

The system includes a plurality of components such as one or more of electronic components, hardware components, and computer software components. A number of such components can be combined or divided in the system. An example component of the system includes a set and/or series of computer instructions written in or implemented with any of a number of programming languages, as will be appreciated by those skilled in the art.

The system in one example employs one or more computer-readable signal-bearing media. The computer-readable signal bearing media store software, firmware and/or assembly language for performing one or more portions of one or more implementations of the invention. The computer-readable signal-bearing medium for the system in one example comprises one or more of a magnetic, electrical, optical, biological, and atomic data storage medium. For example, the computer-readable signal-bearing medium comprises one or more of floppy disks, magnetic tapes, CD-ROMs, DVD-ROMs, hard disk drives, downloadable files, files executable “in the cloud,” electronic memory, and another computer-readable signal-bearing medium.

For the purpose of this application, the undistributed income is equal to the return of capital a user can claim as a tax deduction when purchasing income-producing securities. Undistributed income equals purchased per-share undistributed income times a number of shares purchased. In the case of a purchase, the undistributed income is purchased by the user and then returned to the user when the distribution is paid. The system requires that the purchased shares be held at the end of the payment period. For example, the user can claim the return of capital as a tax deduction. The system calculates the undistributed income using a distribution index.

A user's correct income on a first distribution received after a purchase of a security is therefore determined by an equation:

(1) Correct Income=(Distribution Received−Undistributed Income), where Distribution Received is the distribution received by the user and Undistributed Income is the user's purchased per-share undistributed income multiplied by the number of shares purchased. The Undistributed Income represents a return of capital to the user. This return of capital should not be subject to taxation. If a user does not claim this return of capital tax deduction on their tax forms, they will pay tax on income they did not earn, causing the user purchasing the security to overpay their taxes. For a security purchase, the server computes the undistributed income. The server then sends to the storage one or more of the computed correct income and the computed undistributed income. Preferably, but not necessarily, the server sends to the storage both the computed correct income and the computed undistributed income. The undistributed income is used to adjust a user's tax forms to compute the Correct Income. The Correct Income comprises the Undistributed Income.

For the purpose of this application, a distribution index, also known as a “per-share distribution index,” comprises one or more of an estimate of a security's undistributed income per share for a payment period of interest and an exact value of a security's undistributed income per share for the payment period of interest. According to embodiments of the invention, the distribution index can be divided by the security price to calculate an undistributed income percentage for the payment period of interest. In the case of investment funds, the distribution index comprises a variable that changes at least once in the payment period. Preferably, but not necessarily, in the case of investment funds, the distribution index comprises a variable that changes each day of the payment period. In the case of a purchase, the distribution index multiplied by the number of shares thus represents income that the holder of the security purchased, income that our system deducts from an income distribution. Accordingly, our system enables the holder of the security to avoid being unfairly taxed by allowing the user to claim a return of capital for the portion of the undistributed income that was purchased and subsequently returned to the user. The return of capital should be deductible on the user's taxes. Claiming a return of capital reduces the user's income by the amount of the deduction claimed.

Distribution data comprises information usable to compute the distribution index for the security. According to embodiments of the invention, the system generates a database of distribution data for the security. According to further embodiments of the invention, the system generates a plurality of databases of data, at least one of the databases comprising financial distribution information usable to compute the distribution index for the security. Preferably, but not necessarily, each of the databases comprising financial distribution information is usable to compute the distribution index for the security. Financial distribution information usable to compute the distribution index can be retrieved from a financial data source such as one or more of Bloomberg, FactSet, and Refinitive. The financial distribution information comprises one or more of the security's ex-dividend date, announcement date, a Committee on Uniform Security Identification Procedures (CUSIP) identifier, another unique security identifier, a ticker symbol, a distribution payment frequency, a custom security tag, payment period information for the security, a periodic total distribution per share for the security, a type of distribution for the security, holding period requirements for the security, and information related to one or more of security earnings, security profits, security type, and tax information related to the distribution of the security. For example, the holding period requirements comprise holding period requirements for preferred taxation for the security in a jurisdiction of interest.

According to further embodiments of the invention, following computation of the distribution index, the distribution index can be stored in the database. Alternatively, or additionally, the distribution index can be computed on-demand. According to yet other embodiments of the invention, alternatively, or additionally, the distribution percentage can be stored in the database. According to still further embodiments of the invention, the system uses the distribution index to compute a cumulative distribution income for the security for a period of interest. For example, the period of interest comprises one or more of a day of interest comprised in the payment period, a time of interest comprised in the payment period, and a time frame comprised in the payment period. Alternatively, or additionally, the system computes the distribution index in a single calculation.

According to other embodiments of the invention, after the end of a payment period during which a distribution has been declared by a security, the system retrieves user data. For example, the user data comprises one or more of an accounting of a security purchase or sale, a tax lot, an account number, a tax lot identification number, a long position identifier, a short position identifier, a ticker symbol, a tax cost, a tax basis, and a unique security identifier. For example, the security identifier comprises a Committee on Uniform Security Identification Procedures (CUSIP) identifier. For example, the user data comprises one or more of a day of the security purchase or sale, a time of the security purchase or sale, and a number of shares purchased or sold. For example, and preferably, but not necessarily, in the case of a purchase, the user data describes a purchase by a user during the payment period, wherein the user still owns the purchased security at the end of the payment period. For example, the system retrieves one or more of a user's tax lot history and a user's transaction history. Preferably, but not necessarily, after the end of a payment period during which a distribution has been declared by a security, the system retrieves an accounting of the day, the time, and the number of shares purchased by a user during the payment period and still owned by the user at the end of the payment period. Preferably, but not necessarily, after the end of the payment period during which the distribution has been declared by the security, the system further retrieves the account number, the tax lot, the tax lot identification number, the long position identifier, the short position identifier, the ticker symbol, the tax cost, the tax basis, and the security identifier. Preferably, but not necessarily, after the end of the payment period during which the distribution has been declared by the security, the system retrieves for all purchases and/or sales during the payment period an accounting of the days, the times, and the number of shares purchased by all users during the payment period and still owned by the respective users at the end of the payment period. Preferably, but not necessarily, after the end of the payment period during which the distribution has been declared by the security, the system further retrieves for all purchases and/or sales during the payment period the account numbers, the tax lots, the tax lot identification numbers, the long position identifiers, the short position identifiers, the ticker symbols, the tax costs, the tax bases, and the security identifiers. account number, tax lot identification number long or short position identifier, tax cost, tax basis, and a CUSIP or unique security identifier. Preferably, but not necessarily, the system retrieves the information from one or more of the user, a broker for the user, a custodian for the broker, a transfer agent, a record keeper, and another entity that possesses user information.

According to other embodiments of the invention, the system retrieves information on one of more of a qualifying security purchase and a security sale. The qualifying security purchase comprises security shares purchased during the payment period of interest, wherein the security shares are still owned at the end of the payment period of interest.

Preferably, but not necessarily, the server retrieves the qualifying security purchase information for one or more of multiple securities, multiple users and multiple payment periods. The server then processes the information on the qualifying purchase of securities. The server then calculates the undistributed income from the qualifying purchase of securities.

For a qualifying purchase of securities that occurs in the relevant payment period, the system multiplies a number of shares purchased by the distribution index at a time that the shares are purchased.

Preferably, but not necessarily, for a qualifying security purchase that occurs in the relevant payment period, the server multiplies the number of shares purchased by the distribution index when the shares are purchased. Preferably, but not necessarily, for each qualifying security purchase that occurs in the relevant payment period, the server multiplies the number of shares purchased by the distribution index when the shares are purchased. A qualifying purchase of a security is defined as a purchase occurring during the payment period of interest for which the shares purchased are still owned at the end of the payment period. A purchase of the security followed by a sale within the same payment period does not earn a distribution so there is no distribution for which the system needs to make an adjustment.

The last holder of record system does not have a way to pay income to those users who owned an income-producing security and sold the security before a distribution was paid. Under the current last holder of record system, in this case, undistributed income accrues to the price of the security, pushing up the security price by an amount equal to the undistributed income. Therefore, when a seller sells their securities, they receive their pro rata earned income in the form of a capital gain resulting from the price appreciation. However, in many tax jurisdictions, distribution income is taxed at a lower rate than a capital gain. Accordingly, a security seller can lose income due to an unfavorable tax rate.

The system computes a user's correct income when selling an income-producing security using the following formula:

(2) Correct Income for Security Sale=S*(D*(C−Q)), where S=the number of shares a user wants to sell, where D=the Per Share Distribution index, where C=the tax rate on capital gains or a highest tax rate, and where Q=the tax rate on qualified income or a lowest tax rate.

A security that is purchased and subsequently sold in the same payment period is eligible for income reclassification if the holding period for the tax jurisdiction of interest is satisfied. In this case, the user thereby qualifies for a lower tax rate on income. Securities that are purchased and then sold before the payment period ends do not receive a distribution. Therefore, the system does not claim a return of capital since a distribution was not paid.

The elapsed percentage of the payment period comprises a length of time that has passed since the beginning of the payment period until the day and time of the purchase or sale, divided by a total length of the payment period. For some security types, the elapsed percentage of the payment period can be equal to 1.00. For example, the distribution index for corporate issue equities, such as IBM (International Business Machines, Inc.), can be equal to 1.00.

The server calculates the distribution index using the equation:

$$Distribution Index = \{ \begin{matrix}D for a purchase of a stock ; \\ \begin{matrix}D * {Percentage}_{PaymentPeriod} for \\ purchases of an investment\end{matrix}\end{matrix} \\ fund , where D is a total distribution \\ of the security per share during the payment period , \\ and where {Percentage}_{PaymentPeriod} is the percentage of the \\ payment period that has elapsed at the time of the purchase . \qquad ( 3 )$$

A percentage of the payment period Percentage_{PaymentPeriod} that has elapsed at the time of purchase can in turn be calculated using the following equation:
(4) Percentage_{PaymentPeriod}=T/L, where T=an amount of elapsed time since the payment period began, and where L=a total amount of time in the payment period.

Accordingly, the equation to calculate the distribution Index can also be expressed as:

$$Distibution Index = \{ \begin{matrix}D for a purchase of a stock ; \\ \begin{matrix}( D * \frac{T}{L} ) for a purchase of an \\ investment fund , where :\end{matrix}\end{matrix} \qquad ( 5 )$$

D=the total distribution per share, T=the amount of elapsed time since the payment period began, and L=the total amount of time in the payment period.

When the server multiplies the number of shares purchased by the distribution index, the server thereby generates a result equal to an amount of undistributed income that was purchased by the user and is eligible to be reclassified for tax purposes. The purchased portion of the undistributed income will be returned to the user when the distribution is paid and accordingly, may be eligible to be reclassified for tax purposes so that the user can avoid paying taxes on return of the user's own capital. Using embodiments of the invention, the user is only paying tax on what he or she earned. The server calculates undistributed income using the equation:

$$Undistributed Income = \{ \begin{matrix}S * D for a purchase of a stock ; \\ \begin{matrix}S * ( D * ( T / L ) ) , for a \\ purchase of an investment fund\end{matrix}\end{matrix} , \qquad ( 6 )$$

where: S=number of shares purchased, D=the total distribution per share, T=the amount of elapsed time since the payment period began, and L=the total amount of time in the payment period where:

$$S * ( D * {Percentage}_{PaymentPeriod} ) = S * ( D * \frac{T}{L} ) ,$$

where: S=number of shares purchased, D=the total distribution per share, Percentage_{PaymentPeriod} is the percentage of the payment period that has elapsed at the time of the purchase or sale, T=the amount of elapsed time since the payment period began, and L=the total amount of time in the payment period.

Correct income is defined as the income that should correctly be subject to taxation. The server computes correct income for a purchase of an income-producing security using the equation:

$$Correct Income for Security Purchase = ( Distribution Received - Undistribbuted Income ) = D * S - Undistributed Income = \{ \begin{matrix}D * S - S * D = 0 for a purchase of a stock ; \\ \begin{matrix}D * S - S * ( D * PercentagePaymentPeriod ) \\ for a purchase of an investment fund\end{matrix}\end{matrix} \} = \{ \begin{matrix}0 for a purchase of a stock ; \\ D * S - S * ( D * \frac{T}{L} ) for a purchase of an investment fund\end{matrix} \} = \{ \begin{matrix}0 for a purchase of a stock ; \\ D * S - S * ( D * ( T / L ) ) for a purchase of an investment fund\end{matrix} \} = \{ \begin{matrix}0 for a purchase of a stock ; \\ S * ( D * ( 1 - ( T / L ) ) , for a purchase of an investment fund\end{matrix} \} , \qquad ( 7 )$$

where: D=the total distribution per share, S=number of shares purchased, Percentage_{PaymentPeriod} is the percentage of the payment period that has elapsed at the time of the purchase or sale, T=the amount of elapsed time since the payment period began, and L=the total amount of time in the payment period. The system computes the correct income using one or more of the retrieved user data, the security data, and the distribution data. Preferably, but not necessarily, the system computes the correct income using the retrieved user data, the security data, and the distribution data,

The server calculates a distribution index percentage per share, representing a ratio of the total distribution to the security's price, using the equation:

$$Distribution Index Percentage = \{ \begin{matrix}\begin{matrix}D / P for purchases \\ of a stock ;\end{matrix} \\ \begin{matrix}\frac{( D * \frac{T}{L} )}{P} for a purchase of \\ an investment fund ,\end{matrix}\end{matrix} \qquad ( 8 )$$

where: D=the total distribution per share, T=the amount of elapsed time since the payment period began, L=the total amount of time in the payment period and P=the security's price at the time for which the distribution index percentage is calculated.

A single security can make one or more types of distributions. For example, the security can make at least two types of distributions. These multiple distributions issuable by a single security can have one or more of different payment periods and different distribution frequencies. For example, a security can distribute one or more of income, cash, a short-term capital gain, a long-term capital gain, a special cash distribution, a return of capital, and another distribution type. Terminology for different types of distributions varies from country to country and from jurisdiction to jurisdiction. For example, the payment period for an income distribution can be three months. For example, the payment period for a long-term capital gain can be twelve months. For example, the payment period for a short-term capital gain can be twelve months. Distribution frequencies vary and are set by the security issuer. The server is configured to compute a distribution index for each type of distribution made from a security. The server is configured to process all distribution types. Names and types of distributions can vary by tax jurisdiction. Embodiments of the invention are configured to process any distribution type, regardless of the distribution name or tax jurisdiction.

For at least one distribution type, the server computes the correct income according to the equation (6) using the distribution made according to the distribution type. Preferably, but not necessarily, for each distribution type, the server computes the correct income according to the equation (6) using the distribution made for each distribution type. The server then transmits to the storage one or more of the correct incomes computed for each distribution type and the undistributed income computed for each distribution type. Preferably, but not necessarily, the server then transmits to the storage both the correct incomes computed for each distribution type and the undistributed income computed for each distribution type.

According to other embodiments of the invention, the system computes a true fair market value of the security by subtracting the distribution index value from the market value of the security.

According to further embodiments of the invention, the system can be run in real time throughout the course of a year after each security pays its distribution. Alternatively, or additionally, the system can be run historically for any time period or security for which the database contains the relevant data needed to construct a distribution index.

According to other embodiments of the invention, the system can be used to amend previously filed tax returns.

According to further embodiments of the invention the system can be configured to process a user's transactions in one or more of multiple countries and multiple tax jurisdictions. According to still other embodiments of the invention, the system processes the user's transactions in multiple countries by mapping income data to a corresponding income tax category on a user's tax form in a country of interest. Alternatively, or additionally, the system processes the user's transactions in multiple tax jurisdictions by mapping income data to a corresponding income tax category on a user's tax form in a tax jurisdiction. According to yet other embodiments of the invention, the system generates a report on the user's correct income in the multiple tax jurisdictions. The system then stores the report in the storage.

According to other embodiments of the invention, the system can produce a report supporting a reclassification of income for tax purposes for a security. Preferably, but not necessarily, the system can produce a report supporting a reclassification of income for tax purposes for each security. For example, the report comprises one or more of an amount of correct income, an amount of earned income, an amount of sold distribution income, a type of sold distribution income, an amount of undistributed income that may be one or more of reclassifiable and non-taxable, an amount of return of capital, an adjusted security basis for a processed tax lot, an adjusted security basis for a processed transaction, and data showing adjustments that need to be made to an user's tax forms to ensure they are taxed appropriately.

The following table presents an example of how the system enables an user to seek to avoid losing money as a result of a distribution being included in a price of a security.

| | |
|---|---|
| $ 100.00 | <Today's Purchase Price |
| $ 2.00 | <Tomorrow's Declared Distribution Per Share |
| $ 98.00 | <Tomorrow's Distribution Adjusted Price |
| $ 1.20 | <After Tax Distribution @ 40% Rate |
| $ 99.20 | <Post Distribution After Tax Investment Value |
| −0.80% | <One Day Return on Investment |

This user purchased a share of a security for $100.00 per share. The security pays a $2.00 distribution the following day. The security price falls from $100.00 to $98.00 because the value of the security is reduced by an amount equal to the distribution payable. The user receives a taxable $2.00 distribution. For example, if the distribution is taxable at a rate of 40%, the after-tax distribution is worth $1.20. The after-tax value of the distribution plus the security is equal to $99.20. Therefore, this user realized a negative return of 0.80% in less than 24 hours. This user's income distribution is calculated as $2.00, but the $2.00 is appropriately reclassified as a return of the user's capital. This user should not experience a loss because the user should not be taxed on the return of their invested capital, which the user can document using the system.

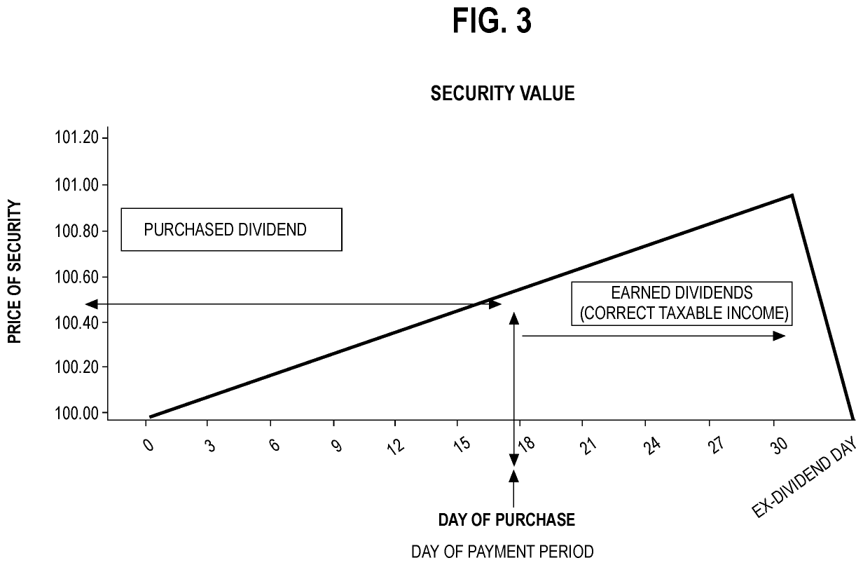

FIG. 3 is a graph showing a price of a security plotted against a day of the security's payment period. FIG. 3 also indicates a portion of a dividend that is purchased by the user and a portion of the dividend that is earned and thus constitutes correct income. The table below presents data regarding the user's investment in tabular form:

| Day | 0 | 3 | 6 | 9 | 12 | 15 | 18 | 21 | 24 | 27 | 30 | Ex-Div. |
|---|---|---|---|---|---|---|---|---|---|---|---|---|
| % of | 0% | 10% | 20% | 30% | 40% | 50% | 60% | 70% | 80% | 90% | 100% | 0% |
| elapsed | | | | | | | | | | | | |
| time | | | | | | | | | | | | |
| Distribution | $0 | $.10 | $0.20 | $.30 | $0.40 | $.50 | $.60 | $.70 | $.80 | $.90 | $1.00 | $0 |
| Index | | | | | | | | | | | | |
| Security | $100 | $100.1 | $100.2 | $100.3 | $100.4 | $100.5 | $100.6 | $100.7 | $100.8 | $100.9 | $101 | $100 |
| Value | | | | | | | | | | | | |

$100.00 < Beginning Security Value
$1.00 < Delcared
40% < Income Tax Rate

FIG. 3 shows the system can compute income of an income-producing security as it builds up over the course of the payment period. FIG. 3 shows a security that has a constant price over a 30-day payment period and that accumulates $1.00 per share of undistributed income that becomes a component of the price. A user who purchases this security on the 18th day of the payment period will purchase $0.60 of undistributed income per share. This user will then earn an additional $0.40 per share of income through an end of the payment period. The security will fall by $1.00 on the ex-dividend day, the 30th day, when the distribution is paid to the user. This figure shows the difference between undistributed income that was purchased and earned income as computed by the system. The system advises the users that they may be taxable on only the $0.40 per share of earned distribution income. Alternatively, or additionally, the system reclassifies the distribution to reflect that only $0.40 per share of the $1.00 distribution is earned income.

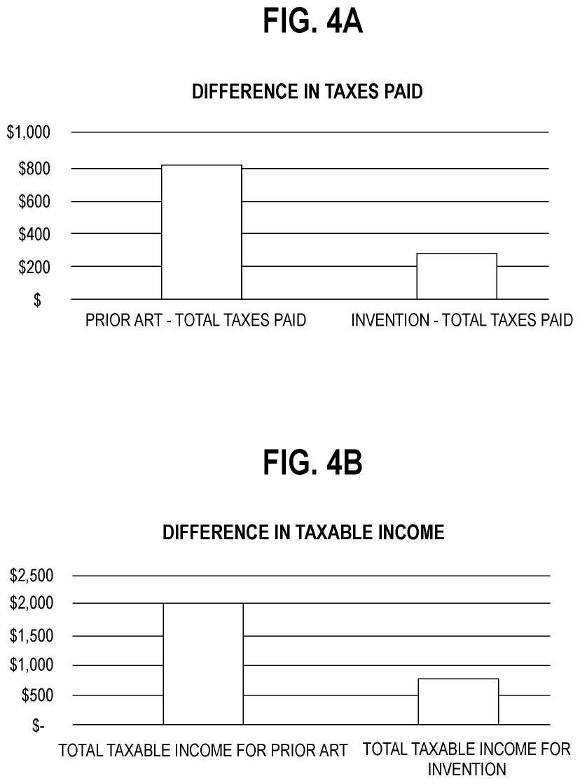

FIGS. 4A-4B are a pair of bar graphs showing how a distribution index can be created for a slightly more complex example. The table below presents data regarding the user's investment in tabular form:

| Day | 3 | 6 | 9 | 12 | 15 | 18 | 21 | 24 | 27 | 30 |
|---|---|---|---|---|---|---|---|---|---|---|
| Percentage of elapsed | 10% | 20% | 30% | 40% | 50% | 60% | 70% | 80% | 90% | 100% |
| time | | | | | | | | | | |
| Distribution Index | $.10 | $.20 | $.30 | $.40 | $.50 | $.60 | $.70 | $.80 | $.90 | $1.00 |
| Number of Shares | | | | | 1000 | | | | 1000 | |
| Purchased | | | | | | | | | | |
| Purchased Undistributed | | | | | $500 | | | | $900 | |
| Income | | | | | | | | | | |
| Prior Art Taxable Income | | | | | $1,000 | | | | $1,000 | |
| Invention Taxable | | | | | $500 | | | | $100 | |
| Income | | | | | | | | | | |

$1.00 < Declared Distribution
40% < Income Tax Rate

FIG. 4A shows the difference in taxes paid under the prior art system and using the system for computing actual income. FIG. 4B shows the difference in taxable income under the prior art system and using the system for computing actual income. FIGS. 4A-4B demonstrate how using the system, a user can avoid paying taxes on a return of capital that should not be taxable. FIGS. 4A-4B show a situation in which the purchaser makes two purchases of the same security on days 15 and 27. The figures sets forth outcomes according to the prior art system and for a user according to the system for computing actual income. The security will distribute a $1.00 per share distribution at the end of the payment period. The user purchases 1,000 shares on days 15 and 27. On day 15, both investors purchase $500 of undistributed income. On day 27, the user purchases $900 of undistributed income. Under the prior art last holder of record system, the user will have taxable distribution income of $1000 for each purchase, or a total taxable distribution income of $2000. Using the system for computing actual income, the user will be able to deduct the $500 of purchased distribution income from the first transaction and $900 of purchased distribution income from the second transaction for a total return of capital deduction of $1,400. Therefore, the taxable income for the user under the prior art system is $2000 and the taxable income for the user using the system for computing actual income is $600.

Assuming a tax rate of 40%, under the prior art system, the user will pay taxes of $800. Using the system for computing actual income, the user will owe taxes of $240. FIGS. 4A-4B show the difference in taxes paid and the difference in taxable income for the user under the two systems, prior art and the system for computing actual income.

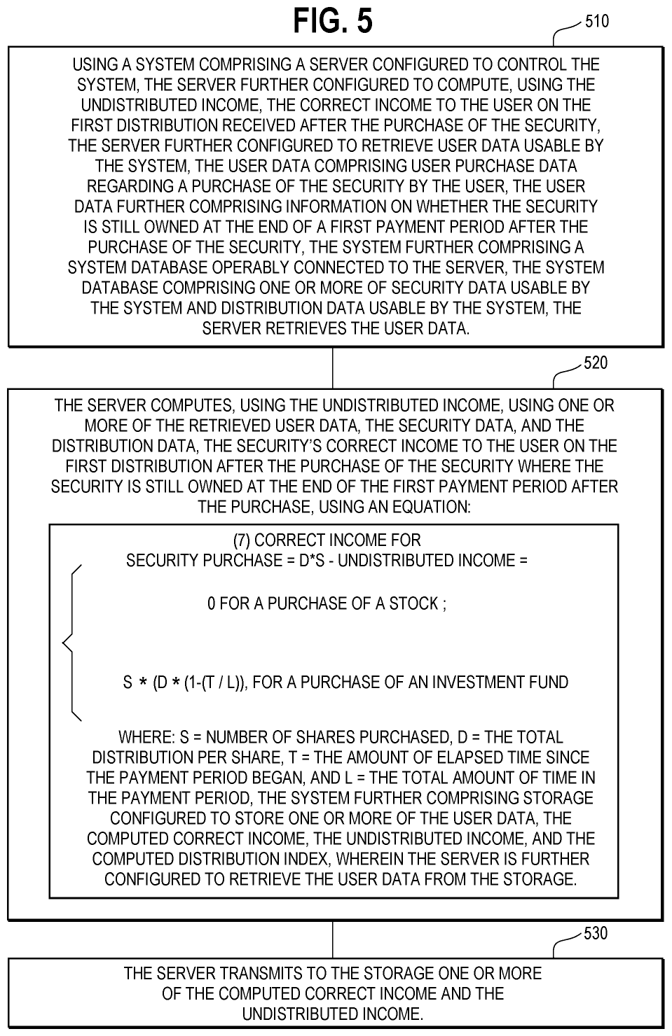

FIG. 5 is a flow chart of a method 500 for computing correct income of a security using undistributed income.

The order of the steps in the method 500 is not constrained to that shown in FIG. 5 or described in the following discussion. Several of the steps could occur in a different order without affecting the final result.

In step 510, using a system comprising a server configured to control the system, the server further configured to compute, using the undistributed income, the correct income to the user on the first distribution received after the purchase of the security, the server further configured to retrieve user data usable by the system, the user data comprising user purchase data regarding a purchase of the security by the user, the user data further comprising information on whether the security is still owned at the end of a first payment period after the purchase of the security, the system further comprising a system database operably connected to the server, the system database comprising one or more of security data usable by the system and distribution data usable by the system, the server retrieves the user data. Block 510 then transfers control to block 520.

In step 520, the server computes, using the undistributed income, using one or more of the retrieved user data, the security data, and the distribution data, the security's correct income to the user on the first distribution after the purchase of the security where the security is still owned at the end of the first payment period after the purchase, using an equation:

$$Correct Income for Security Purchase = D * S - Undistributed Income = \{ \begin{matrix}0 for a purchase of a stock ; \\ S * ( D * ( 1 - ( T / L ) ) , for a purchase of an inestment fund\end{matrix} , \qquad ( 7 )$$

where: S=number of shares purchased, D=the total distribution per share, T=the amount of elapsed time since the payment period began, and L=the total amount of time in the payment period. Preferably, but not necessarily, the computing step comprises computing the correct income using the retrieved user data, the security data, and the distribution data. Block 520 then transfers control to block 530.

In step 530, the server transmits to the storage one or more of the computed correct income and the undistributed income. Block 530 then terminates the process.

Any logic or application described herein that comprises software or code can be embodied in any non-transitory computer-readable medium for use by or in connection with an instruction execution system in a computer system or other system. In this sense, the logic may comprise, for example, statements including instructions and declarations that can be fetched from the computer-readable medium and can be executed by the instruction execution system. In the context of the present disclosure, a computer-readable medium can be any medium that can contain, store, or maintain the logic or application described herein for use by or in connection with the instruction execution system. For example, the computer-readable medium may comprise one or more of random access memory (RAM), read-only memory (ROM), hard disk drive, solid-state drive, USB flash drive, memory card, floppy disk, optical disc such as compact disc (CD) or digital versatile disc (DVD), magnetic tape, and other memory components. For example, the RAM may comprise one or more of static random access memory (SRAM), dynamic random access memory (DRAM), magnetic random access memory (MRAM), and other forms of RAM. For example, the ROM may comprise one or more of programmable read-only memory (PROM), erasable programmable read-only memory (EPROM), electrically erasable programmable read-only memory (EEPROM), and other forms of ROM.

The Appendix contains pseudocode for the method for equitably allocating a financial distribution.

An advantage of embodiments of the invention is the ability to segregate undistributed income of a security from earned income distributions and thereby potentially to help protect purchasers of income-producing securities from being unfairly taxed on return of their own capital when undistributed income is returned in the form of taxable income. Accordingly, the system enables the holder of the security to avoid being unfairly taxed on the undistributed income.

Another advantage of embodiments of the invention is that users may thereby be equipped with information preparing them to seek to be taxed more accurately according to the income they actually earned and not on income that they purchased.

A still other advantage of embodiments of the invention is that they promote accurate taxation of user income by reducing an user's total distribution by the amount of the undistributed income.

A further advantage of embodiments of the invention is they may enable users to seek to more accurately reclassify a capital gain incurred when purchasing an investment fund. For example, users may be able, using embodiments of the invention, to seek to reclassify the capital gains distribution received from an investment fund to accurately compute the users pro rata share of the investment fund's taxable capital gain distribution.

A further advantage of embodiments of the invention is avoiding incorrect classification for tax purposes of income earned by users in a period in which they purchase securities. Another advantage of embodiments of the invention is avoiding the danger that would otherwise result of irreversible investment losses due to users potentially paying more in taxes than they owe.

A further advantage provided by embodiments of the invention is providing a means for correctly classifying income earned by purchasers of income-producing securities such that the taxes paid by users are accurate and better represent actual income earned from the security.

A further advantage provided by the embodiments of the invention is providing the ability, using the method and system for computing undistributed income of a security, to amend previously filed tax returns to accurately reflect the income earned in prior tax years.

A still other advantage provided by the embodiments of the invention is avoiding double taxation that occurs under the current system whereby the purchaser is taxed on undistributed income and the seller is taxed on the capital gain created by the undistributed income.

While the above representative embodiments have been described with certain components in exemplary configurations, it will be understood by one of ordinary skill in the art that other representative embodiments can be implemented using different configurations and/or different components. For example, it will be understood by one of ordinary skill in the art that the order of certain steps and certain components can be altered without substantially impairing the functioning of the invention.

The representative embodiments and disclosed subject matter, which have been described in detail herein, have been presented by way of example and illustration and not by way of limitation. It will be understood by those skilled in the art that various changes may be made in the form and details of the described embodiments resulting in equivalent embodiments that remain within the scope of the invention. It is intended, therefore, that the subject matter in the above description shall be interpreted as illustrative and shall not be interpreted in a limiting sense.

### APPENDIX

Following is pseudocode for the method and system for computing correct income of a security using undistributed income:

# Step 1: Upload tax lot file(open/closed)
# Step 2: Verify all the tax lot records for required field.

| | |
|---|---|
| 1. | For open tax lot file |
| | account_id, |
| | cot, |
| | cusip, |
| | long_short, |
| | open_date, |
| | open_id, |
| | security, |
| | tax_class, |
| | tax_cost, |
| | unit_total, |
| | units, |
| 2. | For close tax lot file |
| | account_id, |
| | close_date, |
| | cot, |
| | cusip, |
| | long_short, |
| | open_date, |
| | open_id, |
| | security, |
| | tax_class, |
| | tax_cost, |
| | unit_total, |
| | units, |
| | total_book_gain_loss, |

# Step 3: Fetch the dividend dates based on cusip and open_date defined
in the tax lot dividend_date = select

```
    up_coming_dividend_date,
    previous_ex_dividend_date,
    announcement_date,
    dividend_frequency,
    dividend_rate
  from
    dividend_data
  where
    cusip = cusip AND
    open_date >= previous_ex_dividend_date AND
    open_date < dividend_ex_date
```

# Step 4: Calculate the missing values from the below list using the rules
for dividend_type and security_tag

| | |
|---|---|
| 1. | up_coming_dividend_date |
| 2. | previous_dividend_date |

```
# Step 5: Calculate the intermediate values as below
  days_in_pmt_period = up_coming_dividend_date −
  previous_dividend_date
  days_since_pmt_period = open_date − previous_dividend_date + 1
  distribution_factor = days_since_pmt_period / days_in_pmt_period
  calculated_tax = up_coming_dividend_amount * distribution_factor
  * units
# Step 6: Add the calculated_tax in the previous step to one of the
following tax_bucket based on rules for dividend_type and security_tag
```

| | |
|---|---|
| 1. | qualified_income_tax_deduction |
| 2. | ordinary_income_tax_deduction |
| 3. | long_term_tax_deduction |
| 4. | roc_tax_deduction |

What is claimed is:

1. A system for computing correct income to a user on a first distribution received after a purchase of a security using undistributed income, comprising:
a server configured to control the system, the server further configured to compute, using the undistributed income, the correct income to the user on the first distribution received after the purchase of the security, the server further configured to retrieve user data usable by the system, the user data comprising user purchase data regarding a purchase of the security by the user, the user data further comprising information on whether the security is still owned at the end of a first payment period after the purchase of the security;
a system database operably connected to the server, the system database comprising one or more of security data usable by the system and distribution data usable by the system, wherein the server is further configured to compute, using the undistributed income, using one or more of the retrieved user data, the security data, and the distribution data, the security's correct income to the user on the first distribution after the purchase of the security where the security is still owned at the end of the first payment period after the purchase, using an equation:
$$Correct Income for Security Purchase = D * S - Undistributed Income = \{ \begin{matrix}0 for a purchase of a stock ; \\ S * ( D * ( 1 - ( T / L ) ) , for a purchase of an investment fund\end{matrix} , \qquad ( 7 )$$
where: S=number of shares purchased, D=the total distribution per share, T=the amount of elapsed time since the payment period began, and L=the total amount of time in the payment period; and
storage configured to store one or more of the user data, the computed correct income, the undistributed income, and the computed distribution index, wherein the server is further configured to retrieve the user data from the storage, wherein the server is further configured to transmit to the storage the one or more of the computed correct income and the undistributed income.

2. The system of claim 1, further comprising a user device operated by a user, the user device operably connected to the server.

3. The system of claim 2, wherein the user device comprises one or more of a desktop computer, a notebook computer, a tablet, a mobile telephone, and a smart watch.

4. The system of claim 3, further comprising a network.

5. The system of claim 4, wherein the network comprises one or more of a server-device network connection operably connecting the server and the user device, a server-database network connection operably connecting the server and the system database, and a server-storage network connection operably connecting the server and the storage.

6. The system of claim 2, wherein the server communicates with the user device via one or more of a network connection, the cloud, and a wired connection.

7. The system of claim 2, wherein the server comprises a login module suitable for use by the user device to log into the server.

8. The system of claim 7, wherein the server further comprises a user interface suitable for use by the user device to interface with the server following a successful login to the server.

9. The system of claim 8, wherein the server retrieves the user data from the user device.

10. The system of claim 9, wherein the server retrieves the user data through the user interface.

11. The system of claim 1, wherein the system database comprises one or more of a security database and a distribution database.

12. The system of claim 1, wherein the system database comprises both a security database and a distribution database.

13. The system of claim 12, wherein the security database comprises security data, the security data comprising a list of income-producing securities for a tax jurisdiction of interest.

14. The system of claim 13, wherein the security data further comprises a tag identifying a security type to be processed.

15. The system of claim 12, wherein the system database comprises a relational database service.

16. The system of claim 11, wherein the distribution database comprises distribution data regarding a security distribution.

17. The system of claim 16, wherein the distribution database further comprises historical security data.

18. The system of claim 17, wherein the historical security data comprises data on historical security distributions.

19. The system of claim 16, wherein the distribution database is configured to obtain distribution data from an external data source.

20. The system of claim 5, wherein the server is further configured to export one or more of the computed correct income and the undistributed income to one or more of the user device and an intermediary authorized by the user.

21. The system of claim 5, wherein the server is further configured to export one or more of the computed correct income and the undistributed income to one or more of the user device and an intermediary authorized by the user.

22. The system of claim 21, wherein the intermediary comprises one or more of an accountant, a tax advisor, a broker-dealer, and a custodian.

23. The system of claim 1, wherein the security distributes one or more distribution types.

24. The system of claim 23, wherein the distribution types are selected from a list comprising: income, cash, a short-term capital gain, a long-term capital gain, a special cash distribution, and a return of capital.

25. The system of claim 24, wherein the server is further configured to compute a correct income and an undistributed income for each distribution type from the security.

26. The system of claim 25, wherein the server transmits to the storage one or more of the correct incomes and the undistributed incomes computed for each distribution type.

27. The system of claim 25, wherein the server transmits to the storage both the correct incomes and the undistributed incomes computed for each distribution type.

28. The system of claim 20, the network further comprising a server-intermediary network connection operably connecting the server and the intermediary.

29. The system of claim 1, wherein the server computes the correct income, using the retrieved user data, the security data, and the distribution data.

30. A method for computing correct income to a user on a first distribution received after a purchase of a security using undistributed income, comprising:
using a system comprising a server configured to control the system, the server further configured to compute, using the undistributed income, the correct income to the user on the first distribution received after the purchase of the security, the server further configured to retrieve user data usable by the system, the user data comprising user purchase data regarding a purchase of the security by the user, the user data further comprising information on whether the security is still owned at the end of a first payment period after the purchase of the security, the system further comprising a system database operably connected to the server, the system database comprising one or more of security data usable by the system and distribution data usable by the system, retrieving, by the server, from the storage, the user data;
computing, by the server, using the undistributed income, using one or more of the retrieved user data, the security data, and the distribution data, the security's correct income to the user on the first distribution after the purchase of the security where the security is still owned at the end of the first payment period after the purchase, using an equation:
$$Correct Income for Security Purchase = D * S - Undistributed Income = \{ \begin{matrix}0 for a purchase of a stock ; \\ S * ( D * ( 1 - ( T / L ) ) , for a purchase of an investment fund\end{matrix} , \qquad ( 7 )$$
where: S=number of shares purchased, D=the total distribution per share, T=the amount of elapsed time since the payment period began, and L=the total amount of time in the payment period, the system further comprising storage configured to store one or more of the user data, the computed correct income, the undistributed income, and the computed distribution index, wherein the server is further configured to retrieve the user data from the storage; and
transmitting, by the server, to the storage, one or more of the computed correct income and the undistributed income.

31. The method of claim 30, wherein the transmitting step comprises transmitting, by the server, to the storage, both the computed correct income and the undistributed income.

32. The method of claim 30, wherein the storage is configured to store the one or more of the user data, the computed correct income, the undistributed income, and the computed distribution index.

33. The method of claim 30, wherein the storage is configured to store the the user data, the computed correct income, the undistributed income, and the computed distribution index.

34. The method of claim 30, wherein the system further comprises a user device operated by a user, the user device operably connected to the server, and wherein the retrieving step comprises retrieving the user data from the user device.

35. The method of claim 30, wherein the security distributes one or more distribution types.

36. The method of claim 35, wherein the distribution types are selected from a list comprising: income, cash, a short-term capital gain, a long-term capital gain, a special cash distribution, and a return of capital.

37. The method of claim 36, wherein the computing step comprises a sub-step of computing, by the server, a correct income for each distribution type from the security.

38. The method of claim 37, wherein the computing step further comprises a sub-step, performed after the sub-step of computing the correct income for each distribution type from the security, by the server, of storing in the storage the correct incomes computed for each distribution type.

39. The method of claim 30, wherein the computing step comprises computing the correct income using the retrieved user data, the security data, and the distribution data.

40. A system for computing correct income to a user on a first distribution received after a purchase of a security using undistributed income, comprising:
a server configured to control the system, the server further configured to compute, using the undistributed income, the correct income to the user on the first distribution received after the purchase of the security, the server further configured to retrieve user data usable by the system, the user data comprising user purchase data regarding a purchase of the security by the user, the user data further comprising information on whether the security is still owned at the end of a first payment period after the purchase of the security;
a system database operably connected to the server, wherein the system database comprises both a security database and a distribution database, wherein the security database comprises security data, the security data comprising a list of income-producing securities for a tax jurisdiction of interest, the security data further comprising a tag identifying a security type to be processed, wherein the system database comprises a relational database service, wherein the distribution database comprises distribution data regarding a security distribution, wherein the distribution database further comprises historical security data, wherein the historical security data comprises data on historical security distributions, wherein the distribution database is configured to obtain distribution data from an external data source;
a user device operated by the user, the user device operably connected to the server, wherein the server communicates with the user device via one or more of a network connection, the cloud, and a wired connection, wherein the server comprises a login module suitable for use by the user device to log into the server, wherein the server further comprises a user interface suitable for use by the user device to interface with the server following a successful login to the server, wherein the server retrieves the user data from the user device through the user interface, wherein the server is further configured to compute, using the undistributed income, using the retrieved user data, the security data, and the distribution data, the security's correct income to the user on the first distribution after the purchase of the security where the security is still owned at the end of the first payment period after the purchase, using an equation:
$$Correct Income for Security Purchase = D * S - Undistributed Income = \{ \begin{matrix}0 for a purchase of a stock ; \\ S * ( D * ( 1 - ( T / L ) ) , for a purchase of an investment fund\end{matrix} , \qquad ( 7 )$$
where: S=number of shares purchased, D=the total distribution per share, T=the amount of elapsed time since the payment period began, and L=the total amount of time in the payment period, wherein the storage is further configured to store both the computed correct income and the undistributed income, wherein the server is further configured to transmit to the storage both the computed correct income and the undistributed income, wherein the server is further configured to export both the computed correct income and the undistributed income to one or more of the user device and an intermediary authorized by the user, wherein the intermediary comprises one or more of an accountant, a tax advisor, a broker-dealer, and a custodian, wherein the security distributes one or more distribution types, wherein the distribution types are selected from a list comprising: income, cash, a short-term capital gain, a long-term capital gain, a special cash distribution, and a return of capital;
storage configured to store one or more of the user data, the computed correct income, the undistributed income, and the computed distribution index, wherein the server is further configured to retrieve the user data from the storage; wherein the server is further configured to compute a correct income for each distribution type from the security, wherein the server transmits to the storage the correct incomes computed for each distribution type; and
a network configured to operably connect two or more of the server, the user device, the system database, the securities data source, the storage, and the intermediary, the network comprising one or more of a server-device network connection operably connecting the server and the user device, a server-database network connection operably connecting the server and the system database, a server-storage network connection operably connecting the server and the storage, and a server-intermediary network connection operably connecting the server and the intermediary.
